(19) United States
(12) Patent Application Publication
(10) Pub. No.: US 2008/0074823 A1
(43) Pub. Date: Mar. 27, 2008

(54) Electromagnetic actuator parallel actuation serial sustaining driving circuit

(76) Inventor: Tai-Her Yang, Si-Hu Town (TW)

Correspondence Address: BACON & THOMAS;4th Floor, 625 Slaters Lane, Alexandria, VA, 22314-1176, US

(21) Appl. No.: 11/526,586

(22) Filed: Sep. 26, 2006

(51) Int. Cl. H01H 47/00

(52) U.S. Cl. 361/155

(57) ABSTRACT

The present invention is a kind of switch device for the control of two sets or above two sets of electromagnetic actuator, driving coil such as electromagnetic brake, electromagnetic clutch, electromagnetic switch, and electromagnetic valve, etc. for parallel actuation, so as to generate better electromagnetic actuation power, and through the control of switch device, take driving coil switch in parallel to reduce the current of driving coil, but still maintain electrically actuated operation in order to save electricity and reduce the generation of heat of electromagnetic actuator.

### BACKGROUND OF THE INVENTION

(a) Field of the Invention

The present invention is to use two sets or above two sets of electromagnetic actuators generating electromagnetic effect through electrical current excited coil, through the control of switch device, for the control of two sets or above two sets of excitation coils for parallel actuation and then switch to series connection to maintain electrically actuated operation.

(b) Description of the Prior Art

Conventionally using two sets or above two sets of electromagnetic actuators generating electromagnetic effect through electrical current excited coil, where each set of excitation coil usually actuates and sustains electrically actuated operation is presenting parallel state, where the excitation current required is larger is its drawback.

### SUMMARY OF THE INVENTION

The present invention is a kind of switch device for the control of two sets or above two sets of electromagnetic actuator, driving coil such as electromagnetic brake, electromagnetic clutch, electromagnetic switch, and electromagnetic valve, etc. for parallel actuation, so as to generate better electromagnetic actuation power, and through the control of switch device, take driving coil switch in parallel to reduce the current of driving coil, but still maintain electrically actuated operation in order to save electricity and reduce the generation of heat of electromagnetic actuator.

### BRIEF DESCRIPTION OF THE DRAWINGS

FIG. 1 is a circuit block chart of the present invention.

### DETAILED DESCRIPTION OF THE PREFERRED EMBODIMENTS

The present invention is a kind of two sets or above two sets of electromagnetic actuators controlled through switch device, driving coil such as electromagnetic braking, electromagnetic clutch, electromagnetic switch, electromagnetic relay, and electromagnetic relay, etc. for parallel actuation, so as to generate better electromagnetic actuation force, and then through the control of switch device, taking driving coil switch as serial to make the electrical current driving coil to reduce, but still sustain the operation of electrical actuation, in order to save electrical energy and reduce the heat generated by electromagnetic actuator.

As after serial connection of excitation coil it is still required to maintain the electromagnetic actuator device presenting under the operation of electrical actuator, therefore the electromagnetic actuation device applicable to the present invention must have the characteristic of maintaining electrically actuating operation after the excitation coil switched to serial connection state.

The present excitation actuator parallel actuation serial sustaining driving circuit is focusing at one or above one electromagnetic actuator with excitation coil, such as electromagnetic brake, electromagnetic clutch, electromagnetic switch, electromagnetic relay, or electromagnetic valve, etc., through the control of switch device, using the excitation coil for parallel actuation and serial sustaining operation in order to save electrical energy.

Two of the above electromagnetic actuator devices are used as preferred embodiment and described below:

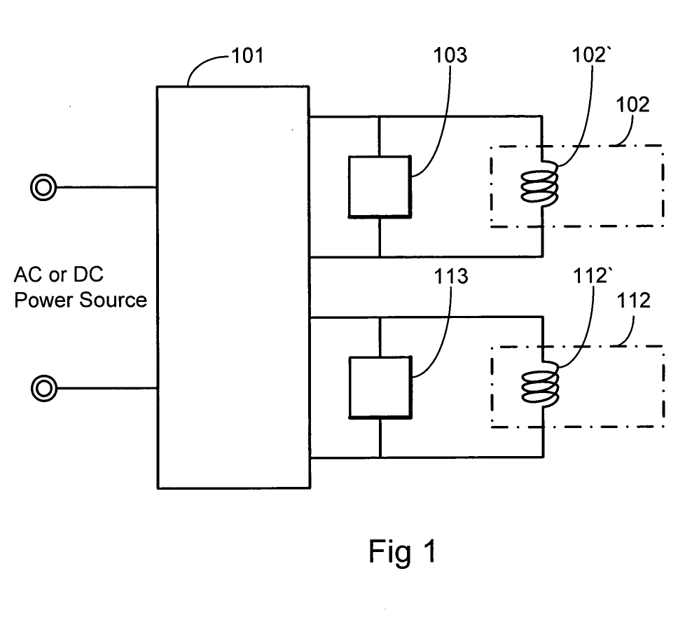

FIG. 1 illustrates the circuit block chart of the present invention, essentially comprised of:

Switch device 101: mechanical or electrical switches, relay, electromagnetic switch or solid state switch component, operated by human power, or mechanical power, or fluid power, or electrical energy; using alternating or direct electrical current energy to deliver to excitation coil of at least two electromagnetic actuators, or for cutting off electricity operation;

Said switch device can be used for the operation of switching, so that the coils of at least two electromagnetic actuators can be first to perform parallel actuation and then switched to serial connection state, and during serial connection the electromagnetic actuator still could maintain the operation of electrical actuation;

Electromagnetic actuators 102 and 112: consist of at least two electromagnetic brake, electromagnetic clutch, electromagnetic switch, electromagnetic relay, and electromagnetic valve with AC or DC electrical power, the electromagnetic actuators has the basic characteristic of sustaining of electrical actuating operation while the electromagnetic coils are in serial connection;

Capacitors 103 and 113: matched AC or DC capacitor or other storage and discharging component based on the specification of electromagnetic actuator, for assistance of coils 102′ and 112′ of electromagnetic actuator in sustaining the stable operation when switch device 101 is switching between series or parallel connection to electromagnetic coils. Such capacitor 103 can either be installed or not installed based on the need.

The operation of the embodiment of FIG. 1 is described as below:

If VA is the normal minimum actuation voltage of the coil of electromagnetic actuators 102 and 112, VH is the holding voltage of normal minimum sustaining electrical actuating characteristics for electromagnetic actuators 102 and 112. If the two electromagnetic actuators 102 and 112 of the preferred embodiment in FIG. 1 installed with the excitation coil of the same excitation actuator as example, the suitable working conditions of the excitation coil of the electromagnetic actuator are: Minimum actuation voltage VA of the excitation coil <2× minimum electromagnetic actuation state holding voltage VH.

In the actual application, this electromagnetic actuator parallel actuation serial sustaining driving circuit, the two or above two electromagnetic actuators installed can be formed by similar or different electromagnetic actuators.

The previously stated capacitor connected to excitation coils 102′ and 112′ in parallel when in use of DC electrical energy for driving excitation coils also can use flying wheel diode for replacement of capacitors or mixed in use; when in use of AC electrical energy for driving excitation coils, it is also possible to be replaced by the short circuit conductivity ring or short circuit shielded windings.

In summary, this electromagnetic actuator parallel actuation serial sustaining driving circuit can use the excitation coil of the electromagnetic actuator for parallel state actuation in order to obtain better actuation response characters and controlling switching excitation coil as serial connection so as to sustain electromagnetic actuation as the operation of electrical actuation with energy savings as characteristics.

1. A kind of electromagnetic actuator parallel actuation serial sustaining driving circuit, for the switching device controlling two sets or above two sets of electromagnetic actuators, for driving coils such as electromagnetic brake, electromagnetic clutch, electromagnetic switch, electromagnetic relay, and electromagnetic valve, etc. to perform parallel actuation in order to generate better electromagnetic actuation force, then through the control of switch device the driving coil is switched into serial connection for the reduction of electrical current in the driving coil but still maintain the operation of electrical actuation in order to save electrical energy and reduce the heat generated by the electromagnetic actuator; the major components include:
Switch device (101): mechanical or electrical switches, relay, electromagnetic switch or solid state switch component, operated by human power, or mechanical power, or fluid power, or electrical energy; using alternating or direct electrical current energy to deliver to excitation coil of at least two electromagnetic actuations, or for cutting off electricity operation;
Said switch device can be used for the operation of switching, so that the coils of at least two electromagnetic actuators can be first to perform parallel actuation and then switched to serial connection state, and during serial connection the electromagnetic actuator still could maintain the operation of electrical actuation;
Electromagnetic actuators (102, 112): consist of at least two electromagnetic brake, electromagnetic clutch, electromagnetic switch, electromagnetic relay, and electromagnetic valve with AC or DC electrical power, the electromagnetic actuators has the basic characteristic of sustaining of electrical actuating operation while the electromagnetic coils are in serial connection;
Capacitors (103, 113): matched AC or DC capacitor or other storage and discharging component based on the specification of electromagnetic actuator, for assistance of coils (102′, 112′) of electromagnetic actuator in sustaining the stable operation when switch device (101) is switching between series or parallel connection to electromagnetic coils; such capacitor can either be installed or not installed based on the need.

2. The electromagnetic actuator parallel actuation serial sustaining driving circuit as claimed in claim 1, wherein the two or above two units of electromagnetic actuators installed can be formed by similar of different electromagnetic actuators.

3. The electromagnetic actuator parallel actuation serial sustaining driving circuit as claimed in claim 1, wherein the capacitor connected in parallel with excitation coils (102′, 112′) when using direct electrical energy for driving excitation coils also can use flying wheel diode to replace capacitor or use in mixture; in using alternating electrical energy for driving excitation coils also can use short circuit conducting ring or short circuit shielded winding as replacement.
